(19) United States
(12) Patent Application Publication
(10) Pub. No.: US 2013/0155005 A1
(43) Pub. Date: Jun. 20, 2013

(54) TOUCH DISPLAY PANEL AND DRIVING METHOD THEREOF

(71) Applicant: Po-Hsiang Liang, New Taipei City (TW)

(72) Inventor: Po-Hsiang Liang, New Taipei City (TW)

(73) Assignee: WISTRON CORPORATION, New Taipei City (TW)

(21) Appl. No.: 13/466,923

(22) Filed: May 8, 2012

(30) Foreign Application Priority Data
Dec. 20, 2011 (TW) 100147517

(51) Int. Cl. G06F 3/044; G06F 3/046

(52) U.S. Cl. 345/174

(57) ABSTRACT

A driving method of a touch display panel is provided. The method is applied to a controller of the touch display panel. The method begins by enabling a capacitive touch unit and an electromagnetic touch unit in the touch display panel. The electromagnetic touch unit includes an electromagnetic pen detect pin that provides a detect signal indicating whether an electromagnetic pen approaches the touch display panel. It is then determined whether the detect signal triggers an electromagnetic pen approach event in which the detect signal switches from a first level to a second level. When the electromagnetic pen approach event is triggered, the capacitive touch unit is driven to switch to an interrupt state to terminate a touch sensing operation of the capacitive touch unit, and a touch sensing operation is performed through the electromagnetic touch unit.

This application claims the benefit of Taiwan application Serial No. 100147517, filed Dec. 20, 2011, the subject matter of which is incorporated herein by reference.

### BACKGROUND OF THE INVENTION

1. Field of the Invention

The invention relates in general to a touch panel and driving method thereof, and more particularly to touch panel having both a capacitive touch unit and an electromagnetic touch unit and driving method thereof.

2. Description of the Related Art

Touch display panels, being one of the important achievements of the ever-thriving technology, are prevalent in various electronic products. In current techniques, a capacitive touch display panel and an electromagnetic touch display panel are two mainstreams of touch display panels. For example, a capacitive touch display panel includes a substrate having transparent electrodes, which are capable of sensing a touch event performed by a conductor (e.g., a user finger) approaching the substrate to correspondingly generate a detectable electronic signal. The touch display panel is then realized through detecting and converting the electronic signal. For example, in an electromagnetic touch display panel, a sensor located at the touch display panel is implemented to sense a magnetic field change caused by an electromagnetic pen approaching the touch display panel. Thus, through sensing the magnetic field change, associated touch positioning operations are performed in response to a user touch event.

Therefore, for the benefit of the great number of users using touch display panels, there is a need for a solution for optimizing utilization conveniences of touch display panels.

### SUMMARY OF THE INVENTION

According to an aspect of the present invention, a touch display panel driving method applied to a processor of a touch display panel is provided. The method begins by enabling a capacitive touch unit and an electromagnetic touch unit in the touch display panel. The electromagnetic touch unit includes an electromagnetic pen detect pin, which provides a detect signal for indicating whether an electromagnetic pen approaches the touch display panel. It is then determined whether the detect signal triggers an electromagnetic pen approach event in which a first level switches to a second level. When the electromagnetic pen approach event is triggered, the capacitive touch unit is driven to switch to an interrupt state to terminate a capacitive touch sensing operation performed by the capacitive touch unit, and a touch sensing operation is correspondingly performed by the electromagnetic touch unit.

According to another aspect of the present invention, a touch display panel is provided. The touch display panel includes a capacitive touch unit, an electromagnetic touch unit and a processor. The electromagnetic touch unit includes an electromagnetic pen detect pin, which provides a detect signal for indicating whether an electromagnetic pen approaches the touch display panel. The processor is coupled to the capacitive touch unit and the electromagnetic touch unit, and determines whether the detect signal triggers an electromagnetic pen approach event in which a first level switches to a second level. When the electromagnetic pen approach event is triggered, the capacitive touch unit is driven to switch to an interrupt state to terminate a capacitive touch sensing operation performed by the capacitive touch unit, and a touch sensing operation is performed by the electromagnetic touch unit.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a block diagram of a touch display panel according to an embodiment of the present invention.

FIG. 2 is a flowchart of a driving method of a touch display panel according to an embodiment of the present invention.

FIG. 3 is a detailed flowchart of the driving method of a touch display panel in FIG. 2.

FIG. 4 is another detailed flowchart of the driving method of a touch display panel in FIG. 2.

FIG. 5 is another detailed flowchart of the driving method of a touch display panel in FIG. 2.

FIG. 6 is yet another detailed flowchart of the driving method of a touch display panel in FIG. 2.

### DETAILED DESCRIPTION OF THE INVENTION

In a touch display panel according to one embodiment, according a detect signal provided by an electromagnetic pen detect pin of an electromagnetic touch unit, a touch sensing operation is performed by selectively implementing either a capacitive touch unit or the electromagnetic touch unit.

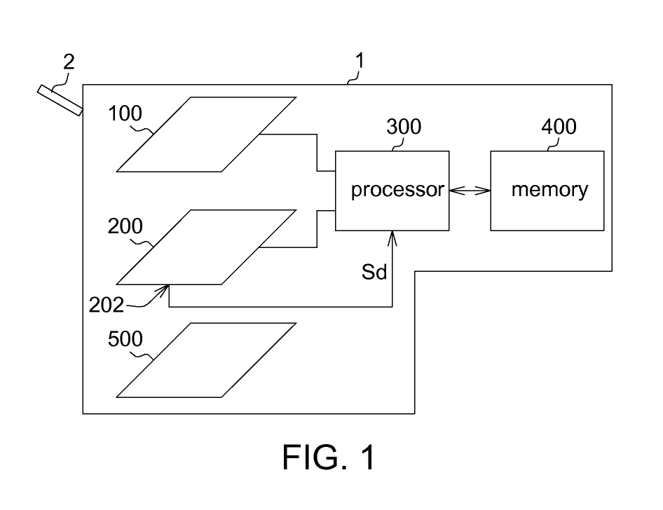

FIG. 1 shows a block diagram of a touch display panel according to one embodiment of the present invention. A touch display panel 1 includes a capacitive touch unit 100, an electromagnetic touch unit 200, a processor 300, a memory 400 and a display panel 500. For example, the capacitive touch unit 100 and the electromagnetic touch unit 200 are sequentially disposed on the display panel 500, which sequentially outputs display images through the electromagnetic touch unit 200 and the capacitive touch unit 100.

The electromagnetic touch unit 200 includes an electromagnetic pen detect pin 202. The electromagnetic pen detect pin 202 provides a detect signal Sd for indicating whether an electromagnetic pen approaches the touch display panel 1. When no electromagnetic pen approaching the touch display panel 1 is detected, the detect signal Sd correspondingly has a first signal level. In contrast, when an electromagnetic pen approaching the touch display panel 1 is detected, the detect signal Sd correspondingly has a second signal level. For example, the first signal level is lower than the second signal level. In other words, a switching of the detect signal Sd from the first signal level to a rising edge of the second signal level is regarded as an electromagnetic pen approach event; a switching of the detect signal Sd from the second signal level of a falling edge of the first signal level is regarded as an electromagnetic pen withdrawal event.

The memory 400 stores a system program, a capacitive touch unit driver and an electromagnetic touch unit driver. The processor 300 is coupled to the memory 400, the capacitive touch unit 100 and the electromagnetic touch unit 200. The processor 300 further executes the system program, the capacitive touch unit driver and the electromagnetic touch unit driver to correspondingly control the units in the touch display panel 1. For example, a communication interface between the processor 300 and the capacitive touch unit 100 is an Inter-Integrated Circuit (I²C) bus, and a communication interface between the processor 300 and the electromagnetic touch unit 200 is a Universal Asynchronous Receiver Transmission (UART) interface.

In one operation embodiment, a driving method of a touch display panel is implemented in the capacitive touch unit driver. Accordingly, the processor 300 registers an interrupt event in the capacitive touch unit driver with respect to the detect signal Sd. In response to the interrupt event of the detect signal Sd, the capacitive touch unit driver stays well informed of associated information of whether an electromagnetic pen approaches the touch display panel 1. The processor 300 performs the driving method of a touch display panel by executing the capacitive touch unit driver. Descriptions of the driving method of a touch display panel according to one embodiment shall be given below.

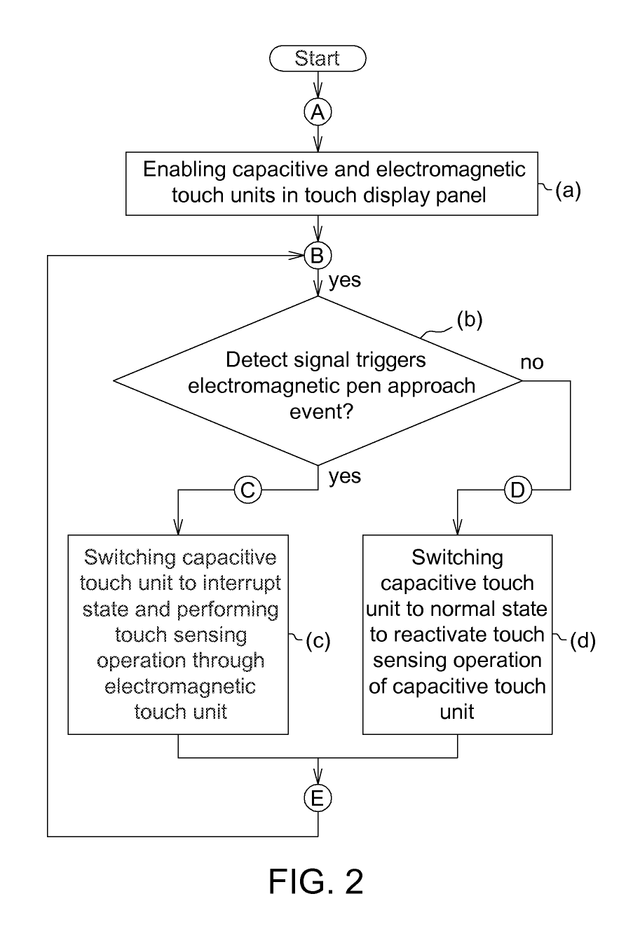

FIG. 2 shows a flowchart of a driving method of a touch display panel according to one embodiment of the present invention. In Step (a), the processor 300 enables the capacitive touch unit 100 and the electromagnetic touch unit 200, so that the capacitive touch unit 100 and the electromagnetic touch unit 200 are operative in a normal state for performing capacitive and electromagnetic touch sensing operations, respectively.

In Step (b), the processor 300 determines whether the detect signal Sd triggers an electromagnetic pen approach event. When it is determined that the detect signal Sd triggers an electromagnetic pen approach event indicating an electromagnetic pen (e.g., an electromagnetic pen 2) is approaching the touch display panel 1, the method proceeds to Step (c). In Step (c), the processor 300 correspondingly drives and switches the capacitive touch unit 100 to an interrupt state to terminate the capacitive touch sensing operation of the capacitive touch unit 100. Therefore, in Step (c), the capacitive touch unit 100 is in an interrupt state, and the processor 300 performs the touch sensing operation through the electromagnetic touch unit 200 in a normal state, so as to prevent the capacitive touch sensing operation performed by the capacitive touch unit 100 from interfering the electromagnetic touch sensing operation performed by the electromagnetic touch unit 200.

In contrast, when the detect signal Sd triggers an electromagnetic pen withdrawal event indicating an electromagnetic pen is drawing away from the touch display panel 1, the driving method of a touch display panel proceeds to Step (d). In Step (d), the processor 300 drives and switches the capacitive touch unit 100 from an interrupt state to a normal state to reactivate the capacitive touch sensing operation of the capacitive touch unit 100. Therefore, in Step (d), the capacitive touch unit 100 is in a normal state, and the processor 300 correspondingly performs the touch sensing operation through the capacitive touch unit 100 in a normal state.

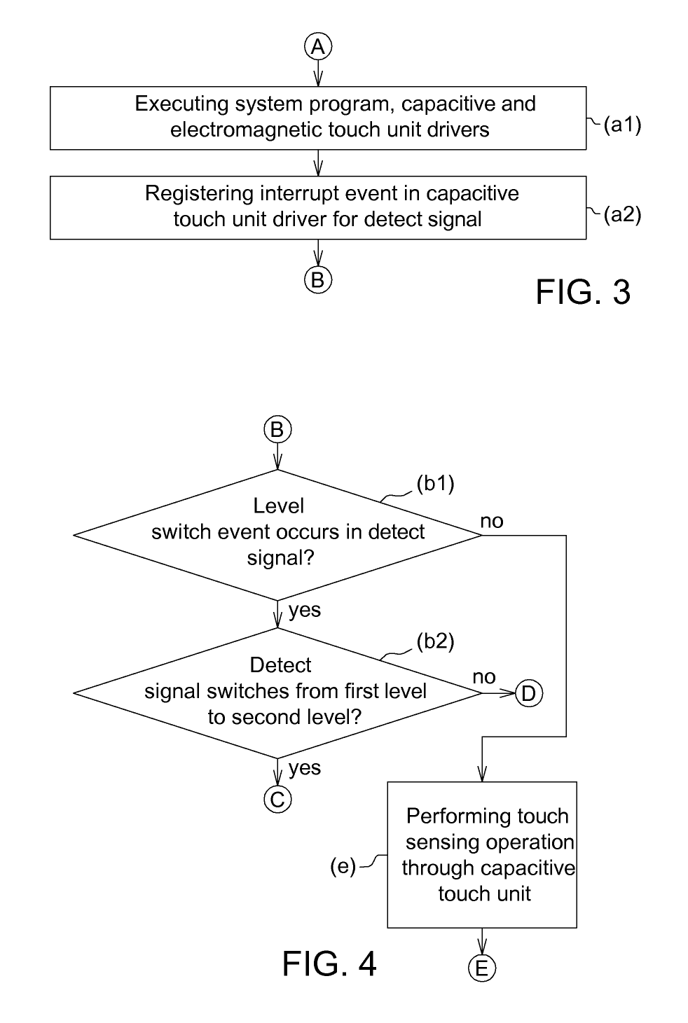

FIG. 3 shows a detailed flowchart of the driving method of a touch display panel in FIG. 2. For example, Step (a) of the driving method of a touch display panel in FIG. 2 further includes Sub-steps (a1) and (a2). In Sub-step (a1), the processor 300 executes the system program, the capacitive touch unit driver and the electromagnetic touch unit driver. In Sub-step (a2), the processor 300 registers an interrupt event in the capacitive touch unit driver with respect to the detect signal Sd.

FIG. 4 shows a detailed flowchart of the driving method of a touch display panel in FIG. 2. For example, Step (b) of the driving method of a touch display panel in FIG. 2 further includes Sub-steps (b1) and (b2). In Sub-step (b1), the processor 300 executes the capacitive touch unit driver and detects whether a level switch event takes places in the detect signal Sd. Step (b2) follows when a level switch event in the detect signal Sd is detected. In Sub-step (b2), the processor 300 further determines whether the detect signal Sd triggers a rising edge of a second level from a first level. When the detect signal Sd triggers the rising edge indicating an occurrence of an electromagnetic pen approach event, the driving method of a touch display panel according to the embodiment proceeds to Step (c). In contrast, when the detect signal Sd triggers a falling edge indicating an occurrence of an electromagnetic pen withdrawal event, the driving method of a touch display panel according to the embodiment proceeds to Step (d).

On the other hand, when a level switch event in the detect signal Sd is not detected, the driving method of a touch display panel according to the embodiment proceeds Step (e). In Step (e), the processor 300 performs the touch sensing operation through the capacitive touch unit 100.

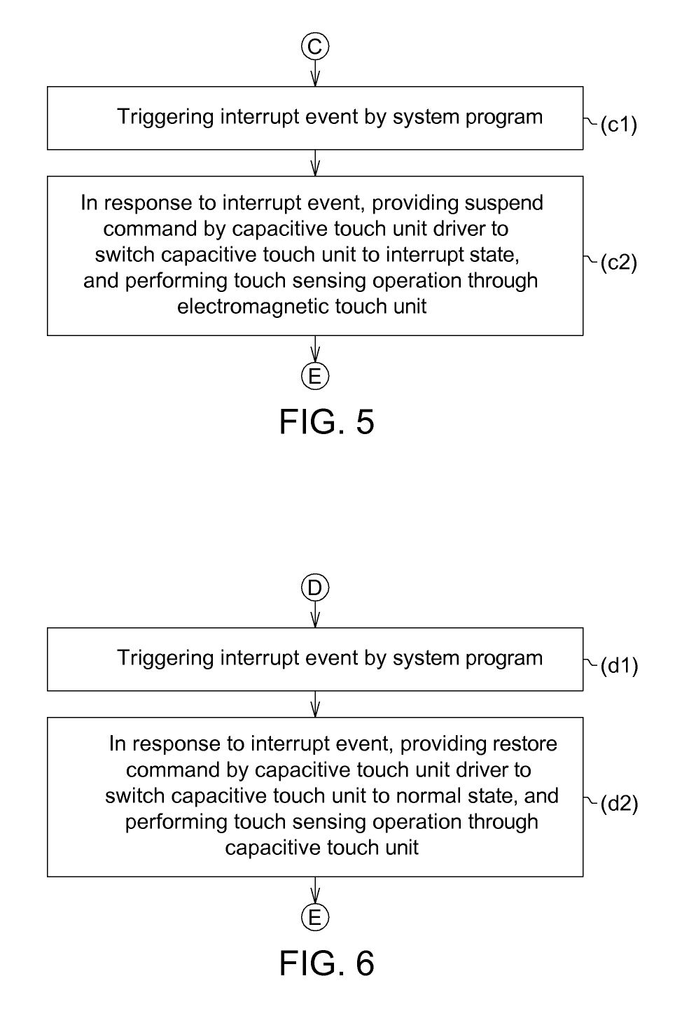

FIG. 5 shows a detailed flowchart of the driving method of a touch display panel in FIG. 2. For example, Step (c) of the driving method of a touch display panel in FIG. 2 further includes Sub-steps (c1) and (c2). In Sub-step (c1), when receiving the electromagnetic pen approaching event, the processing 300 executes the system program to trigger an interrupt event. In Sub-step (c2), in response to the interrupt event, the processor 300 executes the capacitive touch unit driver to provide a suspend command for driving and switching the capacitive touch unit 100 to an interrupt state. In Sub-step (c), the processor 300 correspondingly performs the touch sensing operation through the electromagnetic touch unit in a normal state.

FIG. 6 shows a detailed flowchart of the driving method of a touch display panel in FIG. 2. For example, Step (d) of the driving method of a touch display panel in FIG. 2 further includes Sub-steps (d1) and (d2). In Sub-step (d1), when receiving the electromagnetic pen withdrawal event, the processor 300 executes the system program to trigger an interrupt event. In Sub-step (d2), in response to the interrupt event, the processor 300 executes the capacitive touch unit driver to provide a restore command for driving and switching the capacitive touch unit 100 from an interrupt state to a normal state, thereby reactivating the capacitive touch sensing operation of the capacitive touch unit 100.

With the descriptions above, it is illustrated that in a touch display panel according to one embodiment concurrently provided with a capacitive touch unit and an electromagnetic touch unit, the electromagnetic touch unit includes an electromagnetic pen detect pin that provides a detect signal for indicating whether an electromagnetic pen approaches the touch display panel. Further, the touch display panel according to one embodiment determines whether an electromagnetic pen approach event takes place by referencing the detect signal. In the occurrence of an electromagnetic pen approach event, a capacitive touch sensing operation performed by the capacitive touch unit is terminated, and a touch sensing operation is correspondingly performed by the electromagnetic touch unit. Accordingly, compared to a conventional touch display panel, the touch display panel according to one embodiment is advantaged by effectively managing the capacitive touch unit and the electromagnetic touch unit and preventing the two touch units from interference each other.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A driving method of a touch display panel, applied to a processor of a touch display panel, the driving method comprising:
a) enabling a capacitive control unit and an electromagnetic touch unit in the touch display panel, the electromagnetic touch unit comprising an electromagnetic pen detect pin for providing a detect signal indicative of whether an electromagnetic pen approaches the touch display panel;
b) determining whether the detect signal triggers an electromagnetic pen approach event in which a first level switches to a second level; and
c) when receiving the electromagnetic pen approach event, driving the capacitive touch unit to switch to an interrupt state to terminate a capacitive touch sensing operation performed by the capacitive touch unit, and performing a touch sensing operation by the electromagnetic touch unit.

2. The driving method according to claim 1, further comprising:
d) when the detect signal triggers an electromagnetic pen withdrawal event in which the second level switches to the first level, driving the capacitive touch unit to switch from the interrupt state to a normal state, so as to reactivate the capacitive touch sensing operation of the capacitive touch unit.

3. The driving method according to claim 2, wherein step (a) further comprises:
a1) executing a system program, a capacitive touch unit driver and an electromagnetic touch unit driver; and
a2) with respect to the detect signal, registering an interrupt event in the capacitive touch unit driver.

4. The driving method according to claim 3, wherein step (d) further comprises:
d1) when the detect signal triggers the electromagnetic pen withdrawal event, triggering the interrupt event by the system program; and
d2) in response to the interrupt event, providing a restore command via the capacitive touch unit driver to drive the capacitive touch unit to switch from the interrupt state to the normal state, and performing the touch sensing operation by the capacitive touch unit.

5. The driving method according to claim 1, further comprising:
b1) determining whether a level switch event occurs in the detect signal; and
b2) when the level switch event occurs in the detect signal, determining whether the detect signal is switched from the first level to the second level.

6. The driving method according to claim 5, further comprising:
e) when the level switch event does not occur in the detect signal, performing the touch sensing operation by the capacitive touch unit.

7. The driving method according to claim 1, wherein step (a) further comprises:
a1) executing a system program, a capacitive touch unit driver and an electromagnetic touch unit driver; and
a2) with respect to the detect signal, registering an interrupt event in the capacitive touch unit driver.

8. The driving method according to claim 7, wherein step (c) further comprises:
c1) when receiving the electromagnetic pen approach event, triggering the interrupt event by the system program; and
c2) in response to the interrupt event, providing a suspend command by the capacitive touch unit driver to drive the capacitive touch unit to switch from a normal state to the interrupt state, and performing the touch sensing operation by the electromagnetic touch unit.

9. A touch display panel, comprising:
a capacitive touch unit;
an electromagnetic touch unit, comprising an electromagnetic pen detect pin for providing a detect signal, the detect signal indicating whether an electromagnetic pen approaches the touch display panel; and
a processor, coupled to the capacitive touch unit and the electromagnetic touch unit, for determining whether the detect signal triggers an electromagnetic pen approach event in which a first level switches to a second level;
wherein, when receiving the electromagnetic pen approach event, the processor drives the capacitive touch unit to switch to an interrupt state to terminate a capacitive touch sensing operation performed by the capacitive touch unit, and performing a touch sensing operation by the electromagnetic touch unit.

10. The touch display panel according to claim 9, wherein when the detect signal triggers an electromagnetic pen withdrawal event in which the second level switches to the first level, the processor drives the capacitive touch unit to switch from the interrupt state to a normal state, so as to reactivate the capacitive touch sensing operation of the capacitive touch unit.

11. The touch display panel according to claim 10, further comprising:
a memory, for storing a system program, a capacitive touch unit driver and an electromagnetic touch unit driver;
wherein, the processor executes the system program, the capacitive touch unit driver and the electromagnetic touch unit driver to register an interrupt event in the capacitive touch unit with respect to the detect signal.

12. The touch display panel according to claim 11, wherein when the detect signal triggers the electromagnetic pen withdrawal event in which the second level switches to the first level, the processor triggers the interrupt event by executing the system program; in response to the interrupt event, the processor provides a restore command by executing the capacitive touch unit driver to drive the capacitive touch unit to switch from the interrupt state to the normal state, and performs the touch sensing operation by the capacitive touch unit.

13. The touch display panel according to claim 9, wherein the processor determines whether a level switch event occurs in the detect signal, and further determines whether the detect signal is switched from the first level to the second level when the level switch event occurs in the detect signal.

14. The touch display panel according to claim 13, wherein the processor performs the touch sensing operation by the capacitive touch unit when the level switch event does not occur in the detect signal.

15. The touch display panel according to claim 9, further comprising:
a memory, for storing a system program, a capacitive touch unit driver and an electromagnetic touch unit driver;
wherein, the processor executes the system program, the capacitive touch unit driver and the electromagnetic touch unit driver to register an interrupt event in the capacitive touch unit with respect to the detect signal.

16. The touch display panel according to claim 15, wherein the processor triggers the interrupt event when the electromagnetic pen approach event is received; in response to the interrupt event, the processor further provides a suspend command by the capacitive touch unit driver to drive the capacitive touch unit to switch from a normal state to the interrupt state, and performs the touch sensing operation by the electromagnetic touch unit.
